(19) United States
(12) Patent Application Publication
(10) Pub. No.: US 2013/0261355 A1
(43) Pub. Date: Oct. 3, 2013

(54) Catalyst Compositions for Use in a Two-Stage Reactor Assembly Unit for the Thermolysis and Catalytic Conversion of Biomass

(71) Applicant: KIOR, INC., Pasadena, TX (US)

(72) Inventor: Dennis Stamires, Dana Point, CA (US)

(73) Assignee: KIOR, INC., Pasadena, TX (US)

(21) Appl. No.: 13/788,312

(22) Filed: Mar. 7, 2013

Related U.S. Application Data
(60) Provisional application No. 61/616,533, filed on Mar. 28, 2012.

(51) Int. Cl. B01J 29/82; B01J 29/04; C10G 1/08

(52) U.S. Cl. CPC B01J 29/82; C10G 1/086; B01J 29/04
USPC 585/240; 502/80; 502/79; 502/60; 502/300; 502/174; 502/176; 502/208; 502/355; 502/232; 502/231; 502/200; 502/100; 428/340; 502/81

(57) ABSTRACT

Aspects of the invention relate to a catalyst system for the conversion of biomass material. In an exemplary embodiment, the catalyst system has a specific combined mesoporous and macroporous surface area in the range of from about 1 m²/g to about 100 m²/g. The catalyst system can be used in a two-stage reactor assembly unit for the catalytic thermoconversion of biomass material wherein the thermolysis process and the catalytic conversion process are optimally conducted separately.

### RELATED APPLICATIONS

The present application claims priority to and the benefit of U.S. Provisional Patent Application No. 61/616,533, filed Mar. 28, 2012, the entire disclosure of which is incorporated herein by reference in its entirety.

### FIELD OF THE INVENTION

The invention relates generally to catalyst systems for use in a thermolysis process and/or catalytic conversion process, and more particularly to catalyst systems for use in a thermolysis process and/or catalytic conversion process of solid biomass material.

### BACKGROUND OF THE INVENTION

Biomass, in particular biomass of plant origin, is recognized as an abundant potential source of fuels and specialty chemicals. Refined biomass feedstock, such as vegetable oils, starches, and sugars, can be substantially converted to liquid fuels including biodiesel (e.g., methyl or ethyl esters of fatty acids) and ethanol. However, using refined biomass feedstock for fuels and specialty chemicals can divert food sources from animal and human consumption, raising financial and ethical issues.

Alternatively, inedible biomass can be used to produce liquid fuels and specialty chemicals. Examples of inedible biomass include agricultural waste (such as bagasse, straw, corn stover, corn husks, and the like) and specifically grown energy crops (like switch grass and saw grass). Other examples include trees, forestry waste, such as wood chips and saw dust from logging operations, or waste from paper and/or paper mills. In addition, aquacultural sources of biomass, such as algae, are also potential feedstocks for producing fuels and chemicals. Inedible biomass generally includes three main components: lignin, amorphous hemi-cellulose, and crystalline cellulose. Certain components (e.g., lignin) can reduce the chemical and physical accessibility of the biomass, which can reduce the susceptibility to chemical and/or enzymatic conversion.

Attempts to produce fuels and specialty chemicals from biomass can result in low value products (e.g., unsaturated, oxygen containing, and/or annular hydrocarbons). Although such low value products can be upgraded into higher value products (e.g., conventional gasoline, jet fuel), upgrading can require specialized and/or costly conversion processes and/or refineries, which are distinct from and incompatible with conventional petroleum-based conversion processes and refineries. Thus, the wide-spread use and implementation of biomass to produce fuels and specialty chemicals faces many challenges because large-scale production facilities are not widely available and can be expensive to build. Furthermore, existing processes can require extreme conditions (e.g., high temperature and/or pressure, expensive process gasses such as hydrogen, which increases capital and operating costs), require expensive catalysts, suffer low conversion efficiency (e.g., incomplete conversion or inability to convert lingo-cellulosic and hemi-cellulosic material), and/or suffer poor product selectivity.

There is an urgent need to find processes for converting solid biomass materials to liquid fuels as a way to reduce mankind's dependence on crude oil, to increase the use of renewable energy sources, and to reduce the build-up of carbon dioxide in the earth's atmosphere.

Therefore, a need remains for novel and improved catalysis systems and processes for the conversion of solid biomass materials to liquid reaction products having a high oil yield and having low oxygen content, while reducing the risk of over-cracking the biomass feedstock and/or the bio-oil and bio-oil vapors. There is a further need for such a catalyst system that can be made available at low cost.

### BRIEF SUMMARY OF THE INVENTION

The present invention provides methods, systems and compositions for increasing the yield of bio-oil having a low oxygen content from pyrolysis of solid biomass, which represents a clear economic and process advantage over existing methods and systems. In particular, the present invention provides catalyst systems that can be used in a two-stage reactor assembly unit for the catalytic thermoconversion of biomass material, wherein the thermolysis process and the catalytic conversion process are optimally conducted separately.

Aspects of the invention relate to a dual function catalyst system for use in thermolysis and catalytic cracking of biomass material. In some embodiments, the catalyst system comprises a clay based matrix, such as kaolin, a densifier and a catalytically active material. In some embodiments, the densifier is the clay component of the matrix. The specific combined mesoporous and macroporous surface area is in the range from about 1 m²/g to about 100 m²/g. In some embodiments, the specific combined mesoporous and macroporous surface area is in the range from about 1 m²/g to about 80 m²/g, from about 1 m²/g to about 60 m²/g, from about 1 m²/g to about 40 m²/g, from about 10 m²/g to about 40 m²/g, or from about 20 m²/g to about 60 m²/g. When used in a two-stage reactor, the dual function catalyst system can act as a heat carrier under thermolysis conditions and as a catalyst under catalytic conversion conditions.

In some embodiments, the catalyst system comprises a modified clay, such as calcined clay, metal doped clay, acid leached clay, base-leached clay, delaminated clay, dealuminated clay, or combinations thereof.

In some embodiments, the catalyst system comprises a catalytic active material such as a zeolite, or a phosphated zeolite. For example, the zeolite can be a MFI zeolite, such as ZSM-5, a Faujasite type zeolite or combinations thereof. In some embodiments, the zeolite can be a beta zeolite. In some embodiments, the catalytic active material comprises a metal oxide, metal hydroxide, metal carbonate, metal hydroxyl-carbonate, metal phosphate or combinations thereof. In some embodiments, the catalytic active material comprises a spinel form of the metal or a refractory form of the metal. For example, the metal can be selected from the group consisting of alkaline earth metals, alkaline metals, transitions metals, rare earth metals and combinations thereof.

In some embodiments, the densifier is a refractory material. For example, the densifier can be an alpha alumina, a silica, inert oxides of transition metals, a calcined clay, refractory clay, mullite, calcined diatomite or combinations thereof. In some embodiments, the ratio of matrix to densifier is about 1, about 0.5 or about 0.25.

In some embodiments, the catalyst system further comprises a binder. For example, the binder can be polysilicic acid, aluminum chlorohydrol, aluminum nitrohydrol or combinations thereof.

In some embodiments, the catalyst system is in the form of a microsphere.

Aspects of the invention relate to methods of making a dual function catalyst system for use in conversion of biomass material. In some embodiments, the method comprises preparing a slurry comprising a matrix and a densifier, shaping the slurry into shaped bodies, and subjecting the shaped bodies to calcination at a temperature ranging from about 500° C. and 1,000° C. such as dual function catalyst system has a specific combined mesoporous and macroporous surface area in the range from about 1 m²/g to about 100 m²/g. In some embodiments, the method further comprises adding a binder prior to forming the slurry. In some embodiments, the method further comprises adding a zeolite or a non-zeolitic catalytic material prior to forming the slurry.

In some embodiments, the method further comprises mixing the formed shaped bodies in water in presence of a soluble alumina source and a soluble silica source and a zeolitic seeding material to form a slurry and subjecting the slurry to a temperature of about 175° C. thereby forming in situ grown zeolites.

In some embodiments, the shaped bodies are calcined at temperature of at least 650° C. mixing the shaped bodies in water. In some embodiments, a phosphorous compound can be added before formation of the zeolite or after formation of the zeolite on the shaped bodies.

In some embodiments, the shaped bodies are subjected to ion-exchange, for example with metal cations.

In some embodiments, the pH of the slurry can be adjusted to a pH of about 1 to about 2, for example with sulfuric acid or nitric acid. Optionally, the step of pH adjustment can be followed by calcination.

Other aspects of the invention relate to a multi-stage process for conversion of solid biomass material. In some embodiments, the multi-stage process a first stage comprising the step of subjecting the solid particulate biomass material to a thermolysis reaction in presence of a catalytic system in a first zone of a reactor to produce primary reaction products, and a second stage comprising the step of subjecting at least part of the primary reaction products to a catalytic conversion reaction in presence of the catalytic system in a second zone of the reactor to produce secondary reaction products, wherein the first and second zones of the reactor are in fluid communication.

Other aspects of the invention relate a process for converting solid particulate biomass material. In some embodiments, the process comprises providing the solid particulate biomass in a reactor, thermally pyrolyzing at least a portion of the solid particulate biomass in presence of a catalyst system to form primary reactions products within a lower zone of the reactor, and catalytically converting at least a portion of the primary reaction products into secondary reaction products in the presence of the catalytic system within an upper zone of the reactor. In some embodiments, the primary products are oil, oil vapors or combination thereof.

In some embodiments, the process further comprises a stripper for stripping volatile materials from deactivated catalyst system. In some embodiments, the process further comprises a regenerator for regenerating at least part of the deactivated catalyst system. In some embodiments, the process further comprises a means for recycling back regenerated catalyst system to the first, the second or the first and the second zone of the reactor.

In some embodiments, the first stage process takes place in a first reactor and the second stage process takes place in a second reactor. In some embodiments, the catalyst system acts as heat carrier in the first stage of the process and acts as a catalyst in the second stage of the process.

In some embodiments, the temperature in the first stage is in the range of 350° C. to 600° C. and the temperature in the second stage is equal or higher than the temperature in the first stage.

In some embodiments, the multi-stage process further comprises hydrotreating the reaction products in a hydrotreating reactor, the hydrotreating reactor being in fluid communication with the second zone of the reactor. The hydrotreating reactor can be a fixed bed or an ebullated bed reactor.

In some embodiments, the reactor assembly unit comprises two reactors, the first reactor is a thermolysis reactor, and the second reactor is a catalytic cracking reactor. In some embodiments, the reactor assembly unit comprises three reactors, the first reactor is a thermolysis reactor, the second reactor is a catalytic cracking reactor and the third reactor is a hydrotreating reactor.

### BRIEF DESCRIPTION OF THE DRAWINGS

The features and advantages of the invention will be illustrated in reference to the following drawing. The drawing is not to scale and certain features are shown exaggerated in scale or in schematic form in the interest of clarity and conciseness.

FIG. 1 is a schematic view of a two-stage reactor, for carrying out a specific embodiment of the process of the invention.

### DETAILED DESCRIPTION OF THE INVENTION

The following is a description of certain embodiments of the invention, given by way of example only.

There is an urgent need to find processes for converting solid biomass materials to liquid fuels as a way to reduce mankind's dependence on fossil fuel, to increase the use of renewable energy sources, and to reduce the build-up of carbon dioxide in the earth's atmosphere.

The pyrolysis of biomass material can be carried out thermally, that is, in the absence of a catalyst. An example of a thermal pyrolysis process that may be almost as old as mankind is the conversion of wood to charcoal. It should be kept in mind that solid biomass materials in their native form invariably contain at least some amount of minerals, or ash. It is generally recognized that certain components of the ash may have catalytic activity during the thermal pyrolysis process. Nevertheless, a pyrolysis process is considered thermal if no catalysts are added.

The charcoal making process involves slow heating, and produces gaseous products and solid products, the latter being the charcoal. Pyrolysis processes can be modified so as to produce less char and coke, and more liquid products. In general, increasing the liquid yield of a biomass pyrolysis process requires a fast heating rate, a short reaction time, and a rapid quench of the liquid reaction products.

Fluidized bed reactors and transport reactors have been proposed for biomass pyrolysis processes, as these reactor types are known for the fast heating rates that they provide. In general, heat is provided by injecting a hot particulate heat transfer medium into the reactor.

Pyrolysis processes, in particular flash pyrolysis processes, are generally recognized as offering the most promising routes to the conversion of solid biomass materials to liquid products, generally referred to as bio-oil or bio-crude. In addition to liquid reaction products, these processes produce gaseous reaction products and solid reaction products. Gaseous reaction products comprise carbon dioxide, carbon monoxide, and relatively minor amounts of hydrogen, methane, and ethylene. The solid reaction products comprise coke and char.

In order to maximize the liquid yield, while minimizing the solid and gaseous reaction products, the pyrolysis process should provide a fast heating rate of the biomass feedstock, a short residence time in the reactor, and rapid cooling of the reaction products, and disengagement from the reaction zone. Lately, the focus has been on ablative reactors, cyclone reactors, and fluidized reactors to provide the fast heating rates. Fluidized reactors include both fluidized stationary bed reactors and transport reactors.

Transport reactors provide heat to the reactor feed by injecting hot particulate heat carrier material into the reaction zone. This technique provides rapid heating of the feedstock. The fluidization of the feedstock ensures an even heat distribution within the mixing zone of the reactor.

The biomass to be pyrolyzed is generally ground to a small particle size in order to optimize pyrolysis. The biomass may be ground in a grinder or a mill until the desired particle size is achieved. Particle size reduction of solid biomass requires input of large amount of energy, and consequently is a costly process. Therefore, there is particular need for apparatus and processes for converting solid biomass into gaseous and liquid products that do not require extensive particle size reduction of the solid biomass material feed and do not require extensive upgrading of the reaction products.

Accordingly, aspects of the invention relate to a process for converting solid particulate biomass material to gaseous and liquid fuels that does not require extensive particle size reduction of the solid biomass material feed. Moreover, aspects of the invention relate to apparatuses or processes providing substantially complete conversion of the solid particulate biomass material, while avoiding excessive cracking of the primary reaction products.

Historically, entrained bed reactors or fluidized bed reactors have been used for the conversion of liquid products, using a conversion temperature exceeding the boiling point of the liquid feedstock. An example is the ubiquitous fluid catalytic cracking (FCC) process, used in crude oil refineries for converting heavy crude oil fractions, such as vacuum gas oil (VGO) to lighter products, such as gasoline and diesel blending stocks. At the bottom of an FCC second stage reactor, liquid feedstock is sprayed into a flow of a lift gas in which is entrained a hot, particulate catalyst. The heat carried by the particulate catalyst causes fast evaporation of the feedstock droplets. Due to this fast evaporation, the feedstock components become quickly and evenly heated. In addition, the feedstock vapors expand the volume of gases in the second stage reactor, causing acceleration of both the catalyst particles and the feedstock components, ensuring vigorous mixing of the feedstock and the catalyst particles, and the virtual absence of back-mixing.

Entrained bed reactors operated with a solid particulate feedstock exhibit a mixing behavior that is distinctly different from liquid feedstock systems, such as the FCC reactor. Different from liquid feedstocks, solid biomass particles do not rapidly evaporate upon mixing with hot heat carrier particles. Instead, the solid particles become smaller in a process that can be described as reactive ablation. Initially, only the outer surface of the solid particle becomes hot enough for pyrolytic conversion of the solid biomass material to take place. The pyrolysis products evaporate from the outer shell of the solid particle, exposing an underlying layer of solid biomass material to the reactor temperature. Once hot enough for pyrolysis to take place, this outer layer also evaporates, etc. As a result, the biomass particle becomes gradually smaller as the pyrolysis reaction progresses. It will be appreciated, however, that this process is slow as compared to the evaporation of a VGO droplet in an FCC riser. The process is slowed down further by the virtually inevitable presence of moisture in the biomass feedstock, which needs to evaporate before the temperature of the biomass material can be raised significantly above the boiling point of water.

Since the goal, generally, is to ensure complete conversion of the biomass material, the operator of the entrained bed reactor needs to select reactor conditions that provide a fast enough heat transfer to the solid biomass particles. This can be accomplished by selecting a high enough temperature of the particulate heat transfer material, and a high enough heat transfer medium/feedstock ratio.

Measures necessary to increase the heat transfer to the solid biomass material contribute to the cracking of primary pyrolysis products. Although some cracking of primary pyrolysis products is desirable, excessive cracking increases the coke and gas yields, at the expense of the liquid yield. In some instance, the resulting liquid product has properties that are described as desirable for liquid smoke food flavoring products (low pH, high oxygen content, browning propensity), but that are undesirable for liquid fuels.

Due to these conflicting requirements, it has proven difficult to develop satisfactory processes for converting solid biomass material in an entrained bed reactor. Aspects of the invention allows for the separation of the pyrolysis step and the catalytic conversion step for optimization of biomass conversion. By separating the pyrolysis and the catalytic conversion processes, independent control of the reaction conditions of each process is possible, allowing the optimization of each process. For example, reaction conditions such as temperature of the reactor, catalyst to reaction product material mass ratio, residence time of the reaction products, weight hourly space velocity (WHSV), can be independently controlled. Accordingly, each process is optimized resulting in an overall increase of the performance such as higher yield of bio-oil of bio-fuel product, lower yields of coke formation and overall higher quality of the final conversion product.

In some aspects of the invention, the catalyst systems and processes are described that can be used for converting any type of solid biomass material. In some embodiments, the biomass materials comprise cellulose, in particular lignocellulose. Such materials are abundantly available at low cost. Examples of cellulose-containing materials include algae, paper waste, and cotton linters. Examples of lignocellulosic materials include forestry waste, such as wood chips, saw dust, pulping waste, and tree branches; agricultural waste such as corn stover, wheat straw, bagasse, and energy crops such as eucalyptus, switch grass, and coppice.

### Two Stage Reactor and Process

Some aspects of the invention relate to a two-stage process for the conversion of solid particulate biomass material, comprising (i) a first stage, in which at least part of the solid particulate biomass material is subjected to thermal pyrolysis to produce primary reaction products; and (ii) a second stage, in which at least part of the primary reaction products are catalytically converted to secondary reaction products.

In some embodiments, the two stage process comprises (i) pyrolyzing within a first stage zone of a reactor at least a portion of the solid particulate biomass under appropriate reaction conditions to produce one or more primary reaction products; and (ii) catalytically converting within a second stage zone of a reactor at least a portion of the primary reaction products using a catalyst under appropriate reaction conditions to produce one or more secondary reaction products. In some embodiments, the two stage process occurs in a single reactor. In some embodiments, the reactor is a two-stage reactor.

Some aspects of the invention relate to a two-stage reactor comprising a first stage reactor and a second stage reactor. The second stage reactor is positioned above the first stage reactor. As used herein, the first stage and the second stage correspond to the lower and the upper zone or section of a single reactor. In some embodiments, the two zones of the reactor have different geometries. For example, the lower zone of the reactor has a frustum geometry and the second zone is cylindrical. In some embodiments, the two stages or zones of the reactor can have different diameters. In the first stage reactor, the particulate solid biomass material is thermally pyrolyzed, to form primary reaction products. The primary reaction products are conveyed from the first stage reactor to the second stage reactor. For this purpose, the second stage reactor is in fluid communication with the first stage reactor. In the second stage reactor the primary reaction products are catalytically converted to secondary reaction products.

The term “thermal pyrolysis” as used herein refers to a chemical conversion of a feedstock, such as a solid particulate biomass material, effected by heating the feedstock in the substantial absence of a catalyst, in an atmosphere that is substantially free of oxygen. The atmosphere may be an inert gas, such as nitrogen. Alternatively, the atmosphere can comprise a reducing gas, such as hydrogen, carbon monoxide, steam, recycled process gas which may be modified before it is introduced back into the reactor, or a combination thereof.

Thermal pyrolysis is carried out in the substantial absence of a catalyst. As used herein, the term “catalyst” and “catalyst system” are used interchangeably and refer to any solid particulate inorganic material having a specific surface area (as measured by nitrogen adsorption using the Brunauer Emmett Teller (BET) method in the range of about 0.5 m²/g to about 500 m²/g.

In some aspects of the invention, the catalyst systems described herein can be used in a two stage process and/or in a two stage reactor, in which the thermolytic conversion is conducted separately from the subsequent catalytic conversion of the bio-oil vapors generated by thermolytic conversion of biomass. In some embodiments, the reactor configuration involves a first-stage reactor (e.g. Frustrom type), in which the biomass is thermally converted, and a second-stage reactor, positioned above the first stage reactor, in which catalytic conversion of the bio-oil vapors is taking place. The two-stage reactors are in fluid communication, and the second-stage reactor can have a diameter which is substantially smaller to the diameter of the first-stage reactor. See U.S. application Ser. No. 12/947,449, incorporated herein by reference in its entirety. In some embodiments, the first stage process comprises mixing of the biomass material with the catalyst system and pyrolyzing the biomass to produce one or more primary reaction products (e.g. bio-oil vapors) and the second stage process comprises catalytically converting the primary products using the catalyst system. In some embodiments, the thermal conversion of biomass material in the first-stage reactor takes place at a temperature lower than the temperature required to obtain optimum catalytic cracking in the second-stage reactor. Accordingly, the reactions in each stage can proceed at a different temperature, and the velocities and contact times in each stage can be optimized for each reaction, since the reactors have substantially different diameters. For example, the lower section of the reactor can have a substantially larger diameter than the upper section reactor, and the lower section reactor can operate at lower temperature than the upper section reactor.

In some embodiments, for a stream-lined operation and for optimum heat balancing, the system can further include a stripper and/or a regenerator. The reactor/stripper configuration can be designed such as a stream of spent catalyst taken out of the stripper can be recycled to the first-stage reactor. In some embodiments, the spent catalyst is at a lower temperature than the regenerated catalyst coming out of the catalyst regenerator unit. Thus, the biomass can be contacted and/or mixed with a dual function catalyst system which is at lower temperature than the regenerated catalyst system introduced into the second-stage reactor. In some embodiments, to achieve a lower temperature in the first-stage reactor, a stream of spent catalyst taken out of the stripper can be introduced into the first-stage reactor to obtain a lower temperature. In some embodiments, the temperature of the catalyst and the weight ratio of the catalyst/biomass material can be adjusted so as to maintain desired temperatures in the first stage reactor. The temperature of the first stage reactor can be generally maintained at temperature in the range from about 350° C. to about 600° C., or from about 400° C. to about 550° C., or from about 450° C. to about 500° C.

In some embodiments, the catalyst coming out from the regenerator is introduced into the second-stage reactor which is at a temperature higher than the temperature of the spent catalyst in the first-stage reactor. According to other embodiments, an alternative reactor configuration can be used which involves taking a stream of regenerated catalyst from the regenerator, passing it through a heat exchanger to reduce its temperature, and then introducing it into the first reactor where it is mixed with biomass material and causes the thermolysis of the biomass material to produce the bio-oil vapors. Bio-oil vapors can be directly conveyed to the upper second-stage reactor, wherein the regenerated catalyst is introduced directly from the regenerator at a higher temperature (which has not been cooled down before coming into contact with the bio-oil vapors) to cause the cracking reaction.

Considering the need to separate the thermolytic reactor and the thermo-catalytic reactor and further the need to conduct the two reactions at different temperatures, using a catalyst and a non-catalytic or catalytic heat carrier, an optimal system can be envisioned that can comprise (1) a first stage reactor, such as an ebullated-bed type of pyrolysis reactor, optionally having its own heating unit to provide the heat to the heat carrier, using a non-catalytic or a catalytic material and (2) a second-stage reactor located above the first stage reactor and in fluid communication with the lower section first-stage reactor, wherein the bio-oil vapors are conveyed and mixed with the cracking catalyst. The cracking catalyst can be, in some embodiments, returned from a regenerator in communication with the second stage reactor and at a temperature which is above the temperature of the heat carrier or catalyst used in the first-stage thermolysis reactor. This configuration allows for the independent optimization of both the thermolysis and the catalytic conversion reactions and optimization of bio-oil yield with minimum loss of carbon to coke and gases. In such configuration, the heat carrier introduced into the first-stage thermolysis reactor can be an inert inorganic material, such as sand, or a refractory metal oxide such as alpha-alumina, or a low activity catalyst, or combination thereof. See for example, U.S. patent application Ser. No. 13/262,910, which is incorporated herein by reference in its entirety.

### Dual Function Catalyst Systems

In some aspects of the invention, solid microspheroidal particles, suitable to function both as a heat carrier and as an effective catalyst, can be used. Such microspheroidal particles have the advantage of not requiring the addition of two external regenerators/heat sources to operate the overall unit having two conversion stages. In some embodiments, the microspheroidal inorganic particles can fulfill effectively two separate functions. In particular, the microspheroidal particles can function, in the first stage reactor, as an efficient heat transfer medium, with a low or non-catalytic activity, and, in the second-stage as an active and selective catalyst capable of producing an optimum amount of cracked products with low oxygen content and with a minimum loss of carbon to the coke and CO/CO₂ gaseous products.

One of ordinary skill on the art will appreciate that one of the main problem in designing the composition of such optimal catalyst/heat carrier particles or microspheres having dual-functionality and efficient heat transferring medium properties to cause effectively thermal conversion of biomass to bio-oil vapors, is that most known catalysts and sorbents exhibit bulk pore structures with relatively large pore openings and large surface areas. When catalysts with such bulk pore structures and large surface areas are brought in contact with oil vapors at relatively lower temperatures, they can sorb excessive amounts of the large molecules produced by the thermal conversion of biomass and present in the liquid, vapor or in both phases. It ensures that the trapping of the vapor/oil molecules into the catalyst particles and their subsequent decomposition, can cause excessive formation of coke on the catalyst particles and correspondingly a loss of carbon from the bio-oil yield.

In addition, the reaction conditions in the first-stage reactor, such as longer residence-times, and/or lower temperature, generally enhance the sorption of heavy bio vapor/oil molecules into the inorganic heat carrier/catalyst particles, thus resulting in the formation of excessive amounts of coke on the particles. Furthermore, the vapors produced by the thermolysis of biomass are acidic in nature which enhances the sorption of the bio-oil vapors into the catalyst particles.

Therefore, there is a need to develop catalyst systems with optimal dual-functionality, and with optimal physico-chemical properties, such that the catalyst systems can provide efficiently heat to the biomass in the first-stage reactor while minimizing the sorbing or trapping of oil vapors when present in the first-stage reactor, and such that the catalyst systems exhibit a selective catalytic activity in cracking bio-oil vapors when present in the second-stage reactor. Such catalyst systems would allow for the optimization of the production of oil yield with the minimum amount of oxygen, coke and light gases (CO, CO₂, H₂O and H₂). In some embodiments, the catalyst system is highly coke selective so that a minimum amount of coke is produced in both the first and the second stage process.

In some embodiments, the catalyst systems described herein can be used using a one stage processing in which the pyrolytic conversion and the bio-oil vapor cracking take place at the same time in the same reactor, under the same operating and temperature conditions, and wherein the catalyst systems serve as a heat transferring medium and as a cracking catalyst. The use of such catalysts systems can yield to the formation of minimal amounts of coke under any operating conditions used in the catalytic thermoconversion of biomass processes conducted in single-stage, two-stage or multi-stage configurations. Therefore, it can be considered that the catalyst systems described herein represent biomass thermocatalytic catalysis of universal functionality and usage.

The term “specific surface area”, as used herein, refers to the surface area of the meso and macro pores of a material determined by the BET method, and is expressed in m²/g. Meso porosity is at least about 2 nm up to about 10 nm, and macro porosity is at least about 10 nm. In heterogeneous catalysis, catalytic activity takes place at the interface between the solid catalyst and the liquid or gas phase surrounding it. Formulators of solid catalysts generally strive to increase the specific surface area of catalyst particles in order to maximize the catalytic activity of the catalytic material. It is common to encounter solid catalyst materials having specific surface areas in excess of 100 m²/g or 200 m²/g. Even materials having a specific surface area in excess of 300 m²/g are not uncommon.

Contrary to the prevailing common understanding, that particular catalysts such as FCC or HPC can increase their catalytic activity by increasing their bulk surface area. Surprisingly, it was discovered that these high meso/macroporous catalysts when used in the catalytic thermolysis of biomass, tend to lose activity, produce less bio-oil and produce more coke than is needed to thermally balance the unit.

In this respect, the catalytic systems described herein depart from accepted wisdom in the field of catalysis in that the specific combined meso and macro surface area is not allowed to exceed 100 m²/g. Catalytic systems, in some aspects of the invention, have a specific combined meso and macro surface area of 60 m²/g or less, or a specific surface are of 40 m²/g or less.

Aspects of the invention address these issues by providing a dual function catalytic system for use in the thermal pyrolysis and in catalytic pyrolysis of solid biomass material.

The term “catalytic system”, as used herein, refers to the totality of materials used in the pyrolysis reaction to provide catalytic and/or heat transfer functionality. Thus, the term encompasses a mixture of inert material and catalytic particles. In such a case, the specific surface area of the system is the specific surface area of a representative sample of the mixture of the two components. The term “catalytic system” and “catalyst” are used interchangeably.

The term “catalytic system” also encompasses mixtures of two or more different solid particulate catalytic materials. In such a case, the specific combined meso and macro surface area of the system is the specific combined meso and macro surface area of a representative sample of the mixture of particles.

The term “catalytic system” also encompasses composite particles comprising two or more materials. In such a case, the specific combined meso and macro surface area of the system is the specific combined meso and macro surface area of a representative sample of the composite particles.

The term “catalytic system” also encompasses a system consisting of particles of one catalytic material. In such a case, the specific combined meso and macro surface area of the system is the specific combined meso and macro surface area of a representative sample of the particles.

The specific combined meso and macro surface area of the catalytic system should be high enough to provide meaningful catalytic activity, as inert materials are known to produce liquid pyrolysis products having a high oxygen content. In general, the catalytic system has a specific combined meso and macro surface area of at least 1 m²/g, of at least 5 m²/g, or of at least 10 m²/g.

In some embodiments, the catalyst systems can act as a heat carrier at temperature ranging from about 350° C. to about 600° C. and as a catalyst at temperatures above about 350° C. to 600° C. According to some aspects of the invention, the catalyst systems comprise a specific combined mesoporous and macroporous surface area (referred herein as MMSA) in the range of from about 1 m²/g to about 100 m²/g. In some embodiments, the catalyst systems comprise a specific combined mesoporous and macroporous surface area in the range of from about 1 m²/g to about 80 m²/g, from about 1 m²/g to about 60 m²/g, from about 1 m²/g to about 40 m²/g, from about 10 m²/g to about 40 m²/g, or from about 20 m²/g to about 60 m²/g.

In some embodiments, the catalyst systems comprise a matrix, such as a clay based matrix, a densifier and a catalytically active material. In some embodiments, the densifier and the matrix are comprises a clay, for example kaolin.

In some embodiments, the catalytic systems described herein can be considered as having (1) efficient heat carrier properties with low or non-catalytic activity for the thermo-pyrolysis of biomass and/for the formation of primary products and (2) a selective catalytic activity for the catalytic pyrolysis of solid biomass material or primary products and/or for secondary reactions of pyrolysis reaction products. In some embodiments, the catalyst systems are designed such that catalytic activity of the catalyst systems is curtailed to avoid excessive formation of coke. Use of the catalyst systems described herein in a pyrolysis reaction permits the production of liquid pyrolysis products having an increased oil yield, a low oxygen content ad a minimum loss of carbon to the coke and the CO/CO₂ gaseous products.

### Methods of Making Catalyst System Having Optimized MMSA

### 1. Physical Methods

In some embodiments, denser catalyst particles with smaller meso/macro surface area and porosities (MMSA) can be produced when a dense, non-porous, chemically inert component, also referred as densifier, is introduced in the catalyst slurry containing all the other components before it is spray dried to form the microspheres. As used herein, the term “densifier” refers an inorganic material of high specific density, very low surface area and pore volume. Examples of such densifiers include, but are not limited to, calcined natural clay, cement fines, alpha alumina, silica, zirconia, spinels, mullite, other transition metal oxides and mixed-metal oxides, as well as barite or combination thereof. Additionally, low cost densifiers and MMSA Reducing Agents or fillers include, but are not limited to, refractory clays. For example, high temperature calcined natural clays or steamed clays, such as, but not limited to, kaolinites, smectites, diatomite and combinations thereof, can be used. In some embodiments, calcinations are conducted at high temperatures, such as 1000° C. in order, to decrease the inherent MMSA to values lower than 100 m²/g. Still further, for very low cost materials, used catalysts (FCC with low metals) that have been calcined and have very low MMSA and high density can be finely grounded and incorporated in the slurry to make new catalysts exhibiting low MMSA and high density.

Calcining generally involves heating of the material, for a short period of time (flash calcination) or for several hours or even days. It may be carried out in air, or in a special atmosphere, such as steam, nitrogen, or a noble gas. The purpose of calcining may be various. Calcining is often used to remove water of hydration from the material being calcined, which creates a pore structure. In some embodiments, such calcination is carried out at a temperature of at least 400° C. Mild calcination may result in a material that is rehydratable. It may be desirable to convert the material to a form that is non-rehydratable, which may require calcination at a temperature of at least 600° C. Calcination at very high temperatures may result in chemical and/or morphological modification of the material being calcined. For example, carbonates may be converted to oxides. In general, catalyst manufacturers try to avoid such modifications, as they are associated with a loss of catalytic activity. For the purpose of some aspects of the present invention, however, such phase modification may be desirable, as it can result in a material having a desired low catalytic activity. Calcination processes aiming at chemical and/or morphological modification generally require high calcination temperatures, for example at least 800° C., or even at least 1000° C.

In some embodiments, the catalyst systems having optimized MMAS comprise zeolites suitable for use in the catalytic thermoconversion of biomass exhibiting high bio-oil yields and low coke formation. Suitable zeolites can be, for example, MFI-type zeolites, such as ZSM-5, or Faujasite type zeolites.

### 2. Chemical Methods

In some embodiments, the MMSA can be optimized by varying the pH of the slurry containing a mixture of the catalyst system components. In an exemplary embodiment, the pH of the slurry, containing the catalyst components before spray drying, can be decreased down to a value of about 2, or between about 1 and about 2. The zeolitic component can be introduced just prior the spray drying step so that the formed microspheres have lower meso/macro surface area. It should be understood that crystallinity of the zeolite is less likely to be destroyed if MFI zeolites, such as ZSM, are introduced into the slurry having a low pH, just before spray drying. In addition, high SAR (high silica to alumina ratio) zeolites that have been phosphated before being introduced into the catalyst slurry prior to spray drying are more resistant to crystal degradation when contacted with low pH slurry. Optionally, phosphated zeolites can be calcined, steamed or chemically modified before they are introduced into the slurry containing the other catalyst components and spry dried.

The calcination/steaming procedures can be considered to be of chemical nature because of the presence of chemical reactions taking place within the catalyst particle, such as hydroxyl group condensation, component-particle re-orientation and mixed-metal-oxides formation that are responsible for the reduction of MMSA and of the increase of the microsphere density.

Steam deactivation can be seen as a special type of calcination. The presence of water molecules in the atmosphere during steam deactivation mobilizes the constituent atoms and all groups and all components of the solid material being calcined, which aids its conversion to thermodynamically more stable forms. This conversion may comprise a collapse of the pore structure (resulting in a loss of specific surface area), a reconstitution of the pore size, a change in the surface composition of the solid material, or a combination thereof. Steam deactivation is generally carried out at temperatures of at least 600° C., sometimes at temperatures that are much higher, such as 900° C. or 1000° C.

In some embodiments, an alkaline phosphate-activated clay binder can be used in the slurry together with the zeolite and then spray dried. The formed microspheres can be subjected to calcination at temperatures in the range of 500° C. up to about 1000° C. In some embodiments, the phosphate source can be selected from dibasic or tribasic phosphate or combination thereof. In some embodiments, the phosphate source is dibasic ammonium phosphate.

In some embodiments ACH or ANH (aluminum chlorohydrol and aluminum nitrohydrol) can be used as a binder followed with a high temperature calcination.

### 3. Combinations of Physical and Chemical Procedures

In some embodiments, a binder-matrix comprising a clay-phosphate system or a low pH silica-based binder can be slurried. A chemically inert densifier having low surface area and high density can be introduced to the slurry. In some embodiments, a silica-alumina matrix-binder is prepared at a pH below 2 and a densifier is added. The microspheres can be subsequently calcined at high temperatures. The densifier can include, but is not limited to, alpha alumina, silica or a spinel, calcined diatomite or refractory clay or refractory aluminum oxide produced by calcining bauxite at high temperatures, or combinations thereof.

In some embodiments, zeolites, such as small pore MFI or large pore Faujasite, can be is situ grown into the catalysts particles having optimized MMSA. For example, zeolites can be in situ grown on clay-based microspheres which have been densified to have suitable MMSA before in situ growth of the zeolites.

The general process can be illustrated with reference to kaolin clay. The process can be used for any phyllosilicate material, in particular other clays, such as bentonite or smectite clays. The term “kaolin clay” generally refers to clays, the predominant mineral constituent of which is kaolinite, halloysite, nacrite, dickite, anauxite, and mixtures thereof.

The process generally comprises (a) preparing an aqueous slurry of a kaolin clay, a densifier, optionally a binder and a catalytic active template; (b) shaping the slurry into microspheres; (c) subjecting the slurry to calcination to produce the desired specific mesoporous and macroporous surface area.

Some embodiments involve the preparation of clay microspheres, wherein kaolin (and optimally including a portion of calcined kaolin) and a binder are slurried in water together with an inert dense inorganic fine particle material such as, for example, alpha alumina, zirconia, spinel, refractory clay, mullite (which can function as an inert filler) or used catalyst that has been ground to a size comparable to the particle size of the clay. In some embodiments, the densifier is kaolinite that has been calcined at a temperature in the range of from 850° C. to 1200° C., for a time long enough for the clay to pass through its exotherm and form a non-porous densifier. The slurry is subsequently spray dried to form dense microspheres. The microspheres are calcined at a temperature and time sufficient to obtain a MMSA ranging from about 20 to about 80 m²/g. Subsequently, the microspheres are slurried in water with the addition of a soluble aluminum source and a soluble source of silica, and zeolitic seeds or an organic template suitable to form MFI zeolites, such as ZSM zeolite, and crystallized at 175° C. to obtain ZSM type of zeolite crystallized in-situ on clay-based dense microspheres exhibiting low MMSA.

In some embodiments, the method comprises forming dense microspheres from dense inorganic material and chemically activating (for example, by chemical etching) the surface of the microspheres by reacting first with active sources of silica, alumina, or both silica and alumina, then adding the other components to hydrothermally form MFI zeolites, such as ZSM zeolite. In some embodiments, the microspheres can optionally be calcined/steamed before being activated by reacting with alumina, silica or both chemical compounds.

The aqueous clay slurry is dried in a spray drier to form microspheres. For use in fluidized bed or transport reactors, microspheres having a diameter in the range of from 20 μm to 200 μm, or of from 40 μm to 90 μm can be used. The spray drier is, in some embodiments, operated with drying conditions such that free moisture is removed from the slurry without removing water or hydration from the raw clay ingredient. For example, a co-current spray drier may be operated with an air inlet temperature of about 650° C. and a clay feed flow rate sufficient to produce an outlet temperature in the range of from 120° C. to 315° C. However, if desired, the spray drying process may be operated under more stringent conditions so as to cause partial or complete dehydration of the raw clay material.

The spray dried particles may be fractionated/classified to select the desired particle size range. Off-size particles may be recycled to the slurrying step of the process, if necessary after grinding. It will be appreciated that the clay is more readily recycled to the slurry if the raw clay is not significantly dehydrated during the drying step.

The following examples are provided to further illustrate this invention and are not to be considered as unduly limiting the scope of this invention.

### EXAMPLES

### Example 1

A catalyst water slurry is prepared comprising 15% alpha alumina fine powder, 29% kaolin, 26% sodium silicate and 30% of phosphated ZSM containing 10% phosphorous (as P₂O₅). The slurry is spray dried and microspheres are washed to remove most of the sodium and then calcined at a sufficiently high temperature to reduce the MMSA to about 80 m²/g. Optionally, the slurry is milled in a dyno mill before it is spray dried.

### Example 2

Calcined kaolin is prepared by calcining raw kaolin at 1000° C. for sufficient time to convert kaolin to the mullite phase, and subsequently screened to eliminate agglomerated particles with size over 3 microns. A catalyst slurry is prepared comprising 25% of the high temperature calcined kaolin, 29% kaolin, 26% sodium silicate and 30% of phosphated ZSM containing 10% phosphorous (as P₂O₅). The balance of kaolin in this formulation is 19%. The slurry is spray dried to from microspheres. Microspheres are washed to remove most of the sodium and then calcined at sufficiently high temperature to reduce the MMSA to about 80 m²/g. Optionally, the slurry is milled in a dyno mill before it is spray dried.

Alternatively, the mullite can be prepared by spray drying raw kaolin with 5% silica binder to form microspheres which are calcined at 1000° C. to form the mullite phase and then milled to less than 3-4 micron particle size. Subsequently, the microspheres are mixed in the catalyst slurry together with the zeolite, the binder and the rest of the kaolin and spray dried to form the catalyst particles.

### Example 3

In some embodiments, mullite powder can be prepared as described in Example 2, and can replace all the clay in the sample which is a total of 44%. The processing can be same as in Example 1.

### Example 4

In some embodiments, the pH of the catalyst slurry having the same composition as in Example 3. The pH of the catalyst slurry can be adjusted with sulphuric acid to the level of about 1 to 2, before the formation of microspheres by spray drying

### Example 5

In some embodiments, the components and process are the same as Example 3 except that the clay in the catalyst slurry comprises 22% raw kaolin and 22% mullite clay.

### Example 6

In some embodiments, the components and process are the same as Example 3 except that the microspheres contains 20% raw kaolin and 24% of fine particle silica powder.

### Example 7

In some embodiments, the binder can include of 5% catapal alumina (pseudo Boehmite) and 5% colloidal silica plus 30% ZSM zeolite and 10% phosphorous as P₂O₅. The catapal alumina can be peptised separately with nitric acid. The clay component can include 25% raw kaolin and 25% calcined kaolin fine powder previously converted to the mullite phase. The components can be mixed to form a slurry and the slurry can be milled and then spray dried to form catalyst microspheres. The microspheres optionally can be further calcined to produce a catalyst with the desirable MMSA.

### Example 8

In some embodiments, the composition and process are the same as in Example 7 except that the pH of the slurry is adjusted with nitric acid close to 1 before the spray drying step.

### Example 9

In some embodiments, a binder system similar to that described in U.S. Pat. No. 6,103,949, incorporated herein by reference in its entirety, comprising an alkaline phosphate-activated clay-zeolite composite can be used, except that in this composition a 30% refractory clay (i.e., calcined kaolin to produce a refractory clay with MMSA of about 15 m²/g) can be used. The final catalyst is calcined to produce a MMSA of about 50 m²/g.

### Example 10

Some embodiments involve the use of equilibrium catalysts which are provided from the catalytic thermolysis plant. The equilibrium catalysts can be drawn while the unit is operating and replaced with fresh catalyst in order to maintain a certain level of conversion. The withdrawn used catalyst can be milled to produce fine particle powder material with particle size in the range of 2 to 3 microns. Subsequently, this fine dense material can be used to replace, all or a portion of the kaolin used in Example 1, or in Example 7. Optionally, the equilibrium catalysts can be acid treated to remove any foreign metals that have been deposited on it during its use, before being mixed and used as a densifier in the slurry during formation of the catalyst.

### Example 11

Some embodiments involve the use of a clean equilibrium catalyst which can be withdrawn from an operating catalytic thermoconversion plant after it is treated with an acid to clean up its surface from any adhered metals deposited during its use. Subsequently, the microspheres can be slurried in water, with the addition of an aluminum and silica source and seeds or template. Subsequently, the slurry can be heated at about 175° C. to 200° C. in an autoclave to form MFI zeolite (such as ZSM) on the surface of the microspheres. A phosphorous source can be included in the slurry or applied to the zeolite after it is formed on the microspheres. A calcination treatment can be applied to the microspheres containing the zeolite.

In some embodiments, the spent/equilibrium catalyst is treated with a base such as sodium hydroxide, ammonium hydroxide, sodium carbonate, potassium hydroxide, potassium carbonate, sodium hydroxy carbonate or mixtures thereof, before being introduced into the slurry before zeolitization.

### Example 12

Catalyst compositions prepared according to Example 1 through Example 11, present in microspherical particle shape, can be subsequently calcined or steamed in order to obtain a MMSA suitable for the catalytic pyrolysis of biomass or catalytic upgrading of bio-oils.

The severity of the calcination or steaming reactions (such as temperature and duration of treatment) depends on the particular MMSA that is required. By using bulk densification procedures, involving incorporation of inorganic inert dense filler particles in the catalyst particles, which have very low MMSA as described in the above Examples, and, if necessary, subjecting the catalyst particles to calcination or steaming treatment, it is possible to tailor-design the MMSA and the activity of the final catalyst, optimized to increase bio-oil yield and to reduce oil oxygen content and coke formation. For example, the catalyst can be optimized to have a MMSA of less than about 100 m²/g or in the range of about 60 m²/g to about 20 m²/g. Further embodiments involve the use of lowering the pH of the catalyst slurry to values close or below pH 2 and additionally adding to the slurry a densifying material or filler, such as alpha alumina, mullite, silica, spinel, or an inert transition metal oxide. The slurry containing the zeolite, binder and clay components is then spray dried. If it is still desirable, the microspheres can be calcined/steamed to further decrease the MMSA.

### Example 13

The catalyst compositions described herein are suitable for use in the thermolytic conversion of biomass aimed to achieve maximum production of bio-oil. Addition of sand, in such mode of operation, is known to produce the maximum oil yield but with the maximum amount of oxygen in the bio-oil product. Such oxygen containing oils are very difficult to deoxygenate using hydrotreating processing techniques known in the art which are performed in fixed bed reactors, and which are traditionally used for petroleum derived feeds.

In some embodiments, bio-oil containing the high amounts of oxygen can be deoxygenated/hydrogenated and converted to lighter hydrocarbons by subjecting the bio-oil to an hydroprocessing process in an ebullated-bed reactor, using catalysts known in the art for hydrotreating heavy oils. Accordingly, in some embodiments, pyrolysis of the biomass can be done in the reactor assembly unit designed to produce maximum oil yield with very low oxygen content and having the following processing configuration:

A. Pyrolysis of biomass at low temperature in a fluidized bed using a catalyst described herein having a MMSA less than about 60 m²/g, or in the range of about 10 to 40 m²/g. Such catalyst can produce a high yield of bio-oil with a lesser amount of oxygen than that produced by using sand, and more suitable to be subsequently hydro-deoxygenated.

B. The upgrading step is hydro-deoxygenation of the bio-oil produced in A. above, conducted in an ebullated-bed reactor, using catalysts known in the art for ebullated-bed hydroprocessing.

### Example 14

In some embodiments, an assembly unit comprising a two-reactor system as described above is used for catalytic conversion of biomass. The biomass feed can be introduced in a first stage reactor in the presence of a dual function catalyst described herein, or alternatively, in the presence of an inert metal oxide, such as alpha alumina, silica, sand, refractory metal oxides, refractory clay, zirconia, titania, used catalyst, etc. which can function as a heat transferring medium and/or as a catalyst.

Alternatively, the first-reactor can be an ebullated-bed type reactor being serviced by its own separate regenerator using a heat carrier or catalyst listed above.

The first-reactor can be operated at a temperature lower than the second reactor. The catalyst supplied to the second-reactor can be a dual function catalyst system as described herein, or any other type of catalyst. In some embodiments, the catalysts can be regenerated in a regenerator. In the regenerator, coke deposits can be burned off in a stream of oxygen containing gas.

### Example 15

In some embodiments, the first-stage reactor or ebullated-bed type reactor can be operated at a temperature lower than the temperature of the second-stage reactor chamber, and the catalyst system can be the same in both, the first and the second reactors. In some embodiments, a heat exchanger is placed between the regenerator and the first stage reactor so that the regenerated catalyst can be cooled prior to being injected into the first stage reactor. The rest of regenerated catalyst is injected directly (i.e. without cooling) into the second-stage reactor which operates at a temperature higher than the temperature of the first-stage reactor.

### Example 16

In some embodiments, catalyst systems are prepared by mixing in water, a clay or modified clay, a binder and/or a non-zeolitic catalytic active material. Modified clay can include, but are not limited to, clays modified by metal doping, calcination, acid or base leaching, delamination, dealumination or combination thereof. Examples of such non-zeolitic materials include, but not limited to, oxides, hydroxides, carbonates, hydroxy carbonates and phosphates, of the alkaline, alkaline earth, rare earth, and transition metal groups, and combinations thereof. Additionally, refractory and spinel forms of the above metals can be used as active forms of catalyst activators that can be incorporated into the catalyst systems.

Suitable clay materials include hydrotalcite and the like. Hydrotalcites are layered double hydroxides (LDH) comprising divalent ions such as Mg, Ca, Zn or Ni, and trivalent ions such as Al, Fe, Cr. Suitable hydrotalcites include mixed metal oxides and hydroxides having a hydrotalcite structure and metal hydroxyl salts. Thermal treatments of hydrotalcites induce dehydration, dehydroxylation and loss of charge-compensating anions, resulting in mixed oxides with the MgO-type structure. In some embodiments, the Layered Double Hydroxy clays are calcined at temperatures of at least 800° C., at least 900° C. or at least 1000° C. to form solid-solution containing metal spinels.

In an exemplary embodiment, kaolin, 10% of zinc carbonate, and 10% polysilisic acid binder are mixed to form a slurry. The slurry is spray dried to form microspheres. The microspheres can be subsequently calcined at a temperature sufficient to produce a product having a meso/macro surface area in the range of about 10 m²/g to about 60 m²/g, or in the range of about 20 m²/g to about 40 m²/g.

In some embodiments, densification of the catalyst microspheres, in particular of dual function catalyst microspheres (i.e. acting as a heat transferring medium as well as a catalyst), increases the heat capacity of the microspheres so as to optimize efficient heat transferring medium, which in turn enhances the pyrolysis of the biomass.

### Example 17

In a two-stage assembly reactor configuration, sand can be used as the heat transferring medium in the first-stage reactor mixing chamber, such as an ebullated-bed type of reactor. The sand can be regenerated and returned to the ebullated-bed reactor, at a temperature which is lower, equal, or higher than the temperature of the second-reactor. Catalyst systems, such as the one described herein, can be introduced in the second-stage reactor, in which the bio-oil/bio-oil vapors produced in the first-stage reactor are catalyzed. The temperature of the second-stage reactor can be higher, the same, or lower than the temperature of the first-reactor. In some embodiments, a mixture of sand and catalyst system can be used. It should be noted that the catalyst systems as described herein can have a density and attrition resistance similar than the density and attrition resistance of sand. In some embodiments, the ratio of sand to catalyst can be optimized to provide for the desired heat transfer and catalytic activity of the sand and catalyst mixture. For example, the ratio can comprise ⅓ of sand and ⅔ of catalyst system.

### Example 18

In some embodiments, after shaping the catalyst into microspheres, clay microspheres can be impregnated with an alkaline metal compound such as a carbonate, an hydroxide or an hydroxyl carbonate, and subsequently calcined to fix the metal oxide active sites on the clay microspheres.

### Example 19

In some embodiments, a reactor arrangement wherein the second stage reactor is a Frostrum (a larger diameter reaction chamber) and is located on top of a riser, which has a smaller diameter cylindrical pipe reactor section, can be used. In this example, the biomass can be introduced at the bottom of the riser (or pipe reactor) together with a catalyst stream. In some embodiments, the catalyst can be been cooled down after being regenerated in a regenerator. In some embodiments, a stream of biomass particles, a stream of cooled catalyst and a flow of lift gas is injected in the first stage reactor. At the temperature of the first stage reactor, the biomass material undergoes thermolysis to form primary products (e.g. biomass oil and vapors). A second stream of catalyst can be introduced into the second-stage upper reactor. The catalyst can be delivered directly to the second-stage reactor, without cooling, at a temperature higher than the temperature of the first-stage reactor. The biomass oil and vapors enter in contact with the catalyst present in the second stage reactor at a higher temperature. In an exemplary embodiment, the catalyst used in this dual-reactor assembly is characterized by a low meso/macro surface area which is less than about 100 m²/g, or less than 60 m²/g.

Subsequently, the oil/vapors produced in the second-stage reactor, after being contacted with the hot catalyst and undergoing catalytic cracking, are conveyed to an ebullated-bed hydrotreating reactor which can be coupled to the second stage reactor.

Other versions of reactor assembly include, for example, the use of only one reactor, in which the pyrolysis and cracking of the oil and oil vapors take place. The resulting products (e.g. cracked oil and oil vapors) can be conveyed to the ebullated-bed hydrotreating reactor.

### Example 20

In some embodiments, the two-stage reactor assembly includes a bottom first stage reactor, such as is an ebullated gas-lifted bed reactor, wherein the biomass material can be introduced and mixed with a heat carrier such as hot sand (SiO₂) or any material having suitable heat capacity and heat transferring properties. In some embodiments, the heat carrier can include, but is not limited to, metal oxides such as alumina, silica, titania, zirconia, and refractory metal oxides. In some embodiments, low cost materials such as modified minerals including, but not limited to, diatomaceous earth (diatomite) barite, waste solid materials such as used catalysts, cements, and fly ash that has been formed into microspheres, can be used.

It is known that the use of sand as a heat transferring medium allows for quick heat transfer, and fast immediate disengagement of the oil vapors. It has been reported that high oil yields are produced which are in the range of 60% to 80% based on the dry weight of pine wood feedstock. The oxygen content, depending on the operating conditions, usually is in the range of 30% to 40%.

In some embodiments, the first stage reactor is an ebullated-bed type reactor and is in pneumatic communication with the second stage reactor. The primary reactions products, such as oil vapors from the first stage reactor can be optionally quenched, and conveyed into the second-stage reactor. In some embodiments, the second stage reactor can operate at the same or at a higher temperature than the temperature of the first stage reactor. In some embodiments, the second-stage reactor is operated at a temperature higher than the first stage reactor.

In some embodiments, the second-stage reactor comprises a catalyst system having a MMSA suitable for catalytically cracking the biomass material. The operating conditions of the second-stage reactor can be optimized to produce the maximum oil yield with an oxygen content of less than 30%, or in the range of 10 to 20%. The catalyst system can have a MMSA of less than about 100 m²/g, or less than 60 m²/g. In some embodiments, the catalyst system comprises a zeolite. Yet in other embodiments, the catalysts system does not comprise a zeolite.

In some embodiments, the bio-oil is upgraded to a feedstock which is compatible with those of petroleum derived oils and can be used as a blend for diesel and other fuels.

In some embodiments, the oil processed in the second-stage reactor, can be quickly quenched, and conveyed to a hydroprocessing (deoxygenation) reactor. Hydrotreatment of the bio-oil can be conducted in an ebullated-bed reactor as described in U.S. Pat. Nos. 6,436,279, U.S. Pat. No. 4,420,644 and U.S. Patent Application 2011/0167713, incorporated herein in their entirety.

In some embodiments, bio-oil produced from the first stage or second stage process, in the first stage or second stage reactor, can be subjected to a distillation step before the hydrotreatment step. The hydrotreatment step can be conducted in an ebullated-bed or a fixed-bed hydroprocessing reactor using a hydroprocessing catalyst in an oil slurry. Any suitable hydroprocessing catalysts for upgrading heavy residue oil feeds known in the art can be used.

### Example 21

In some embodiments, a third-stage reactor, such as an ebullated-bed type reactor operating with an oil slurry comprising an HPC catalyst can be used. Ebullated-bed slurry processes suitable to upgrade bio-oil produced from the first or second-stage conversion process can include the H-oil and the LC-Finning process.

In some embodiments, a reactor configuration having an assembly of two or three reactors, such as a thermolysis reactor, a catalytic bio-oil cracking reactor and an ebullated-bed hydroprocessing reactor can be used. Such reactor configuration allows for the conversion of biomass material into high quality bio-oil.

### Example 22

In some embodiments, a reactor configuration assembly comprising a thermoconversion reactor and an ebullated-bed reactor can be used. The thermoconversion reactor, can have any suitable design and configuration (see for example U.S. patent application Ser. No. 12/947,449), such as Frostrum type reactors. Biomass material can be converted into bio-oil and/or bio-oil vapors in the presence of a heat transferring medium or heat carrier or both. The heat carrier can be an inorganic material, like sand, corundum, or other refractory metal oxides, or can be a low activity, low meso/macro surface area and with low bulk active site accessibility catalyst as described herein. In some embodiments, the reactor can operate at relatively low temperature and long residence times. The bio-oil produced by the thermolysis reactor can be subsequently hydrotreated in an ebullated-bed reactor to produce low oxygen content upgraded bio-oil.

### Example 23

In some embodiments, a reactor configuration assembly comprising three reactors can be used. The first reactor can be a thermolysis reactor, employing an inert inorganic material, such as like sand or alpha alumina, as a heat transferring medium, and in which the biomass material is converted into bio-oil/vapors. A second reactor employing a low activity/low MMSA catalyst as provided herein, can be used to catalytically crack the bio-oil/vapors produced in the first reactor. The third reactor can be an ebullated-bed type of reactor, in which the bio-oil is hydrotreated to produce a high quality upgraded bio-oil that can be used in transportation fuels. Optionally, the bio-oil produced by the thermoconversion reactor, or by the catalytic cracking reactor, can be distilled and optionally separated into distillates and bottoms. The distillates can be hydrotreated in the ebullated-bed reactor.

### Example 24

In some embodiments, the catalyst system and the processes can be designed such that oil/oil vapor can be quickly disengaged from the catalyst systems, thereby optimizing the functionality of such catalyst systems. One of skill in the art will appreciate that the reduced absorptive capacity (and high diffusion limitation with very low or no bulk accessibility) of the catalyst particles, coupled with a fast disengagement and/or quenching of the products produced by the catalytic cracking of the oil/oil vapors results in a lower coke formation and in an increase in oil yield. In some embodiments, the cracking reaction zone and the stripping/quenching zones can be located in close proximity. The produced oil can be subsequently hydrotreated in a fixed-bed or in ebullated-slurry bed hydrotreater.

### Example 25

In some embodiments, conversion of the biomass is a two-stage process, involving a first-stage Frostrum type reactor, wherein the biomass is mixed with an efficient non-catalytic heat transferring medium, such as sand, refractory metal oxides, spinels, calcined clays, etc. and pyrolysed. The bio-oil/oil vapors that are produced can be conveyed to the stripper chamber in which the catalyst system described herein is introduced, and which is at a higher temperature than the heat transferring medium, to catalytically crack the oil/oil vapors which are fast quenched/stripped in the stripping chamber.

The oil produced can be further hydrotreated in a fixed-bed or ebullated-bed hydrotreater. Such assembly of reactors allows for a fast heating of the biomass and rapid catalytic cracking and quenching of the cracked products.

By using ebullated-bed hydroprocessing type of reactors, in place of the typical fixed-bed reactor types, heavier, dense bio-oils containing high amounts of oxygen can be hydrotreated. Such bio-oils are difficult to process in the regular fixed-bed hydrotreaters used to treat petroleum derived heavy residues. Therefore, bio-oil feeds containing high amount of oxygen and being more difficult to process can be hydrotreated in an ebullated-bed type hydrotreater whereas such high oxygen containing feed cannot be processed in a fixed-bed hydrotreater.

In addition, catalysts systems described herein can be used in upgrading the bio-oils using ebullated-bed reactors described in the H-oil technology and in the LC-Finning technologies to produce transportation fuel, blendable light and middle distillates.

Generally, in an ebullated-bed heavy oil (residue) or bio-oil processing, the hydrogen, together with the heavy oil, is fed up-flow through a catalyst bed, that expands, and back-mixes the bed, so there is no plugging and a low pressure drop. See for example, “Recent Advances in Heavy Oil Hydroprocessing Technologies” Yuandong Liu, et al, Recent Patents on Chemical Engineering 2009, 2, 22-36; U.S. Pat. Nos. 3,617,524; 3,926,783; 6,436,279; 4,420,644 and U.S. Patent Application 2011/0167713, incorporated by reference herein in their entirety.

### Example 26

In some embodiments, using any of the reactor types and assemblies described in Examples 13 through 25, the catalyst systems can comprise MFI type zeolites or Faujasite type zeolites which are in-situ grown on densified clay-based microspheres having suitable MMSA. In some embodiments, zeolite seeds can be used to grow Faujasite type zeolites or ZSM-5 type zeolites in-situ on clay-based microspheres. See for example, U.S. Pat. No. 7,344,695, incorporated by reference herein in its entirety.

It should be noted that zeolitic catalysts produced by the components and process known in the art, are not suitable for use in the catalytic thermoconversion of biomass or upgrading the biomass derived oil vapors. This is due to the fact that catalyst microspheres produced by the in-situ zeolite growth methods as well as FCC or FCC-additives produced by the component slurry compounding and spray drying methods, exhibit large meso and macro large pore sizes and surface areas, which cause excessive amounts of sorption of the large molecules present in the bio-oils, in particular when the catalyst and the bio-oil/bio-oil vapors are in contact with the catalyst at relatively lower temperatures. The absorption of the larger bio-oil molecules and their trapping into catalyst microspheres can cause the molecules to decompose and form coke, which in turn blocks the catalytic active sites and results in loss of catalyst activity and selectivity.

Accordingly, in some embodiments, catalyst microspheres are densified to reduce the pore volume and meso/macro porosity and reduce the absorptive capacity and trapping of the molecules present in bio-oils. For example, the catalyst systems can be prepared by mixing metakaolin and a calcined clay, and optionally a binder, to form a slurry and spray drying the slurry to form microspheres. In some embodiments, the calcined clay can be a smectite, kaolinite, or diatomite which has been calcined at a high temperature to form a refractory mixed oxide exhibiting surface area of less than about 10 m²/g, or less than 5 m²/g.

In some embodiments, the refractory clay can be replaced with other refractory metal oxides, such as, but not limited to, alpha alumina, silica, titania, zirconia, calcined diatomite, calcined bauxite, and the like. The ratio of the metakaolin to non-porous refractory densifier can be in the range of 1, 0.5, or 0.25.

Subsequently, the microspheres can be slurried in water, which may contain a soluble compound bearing aluminum, and/or a soluble compound bearing silica, and a seeding compound. The seeding compound can be, but is not limited to, seeds that are used to crystallize NaY (Faujasite) zeolite, or ZSM-5 seeds or a template. The slurry can be aged at 170° C. to form ZSM-5. By changing the composition, and aging process, the zeolite formed in-situ can be a Faujasite type zeolite.

In some embodiments, phosphate can be added to the slurry before aging, or to the final zeolitized microspheres to stabilize the zeolite, such as ZSM-5. The microspheres can be calcined or steamed after the aging. Alternatively, phosphate can be applied to the microspheres after the calcination. Optionally, the zeolitized microspheres can also be ion-exchanged with metal cations known in the art, for example, sodium, hydrogen or ammonium ions originally present in the zeolite.

These catalyst systems can be used in the catalytic pyrolysis of biomass, or in the upgrading and the catalytic conversion of bio-oils and bio-oil derived vapors.

### Example 27

In some embodiments, methods for preparing the catalyst system comprises subjecting the clay-based microspheres to calcination at high temperatures, for example over 650° C., to form a refractory clay exhibiting surface areas of less than 5 m²/g. The microspheres can then be slurried in an aqueous solution containing a source of aluminum, a source of silica, and seeds, and the slurry can be aged at 170° C. to 190° C. to form ZSM-5 on the surface of the refractory clay-based microspheres. Phosphation of the zeolites can be performed during the aging process or after formation of the zeolites, with or without an intermediate calcination.

### Example 28

In some embodiments, used catalyst system are reactivated in order to reduce manufacturing costs. In particular, catalyst systems comprising MFI zeolites which have been deactivated by being used in hydrocarbon cracking reactions (such as in processes wherein the oil feed is a petroleum type or bio-oil type) can be slurried in water with the addition of an alkaline, a silica, an alumina source, and seeds or template for the formation of ZSM-5 zeolite. The slurry can be aged at 170° C. to 190° C. to re-form the ZSM-5 on the equilibrium catalyst.

Other methods of reactivating spent catalyst involve an aging step of the equilibrium catalyst in a slurry containing NaOH, before the other components, including the seeds or template, are added. The slurry is being aged at, for example, 175° C. to form the ZSM-5 zeolite on the equilibrium catalyst microspheres. Subsequently, the rejuvenated re-zeolitized catalyst can be phosphated, ion-exchanged, steamed or calcined before use.

### Example 29

The following is a description of an embodiment of the invention, given by way of example only and with reference to the drawing. In the illustrated embodiment, the process is carried out in a two-stage reactor, in which the first stage reactor is operated as an entrained fluid bed reactor.

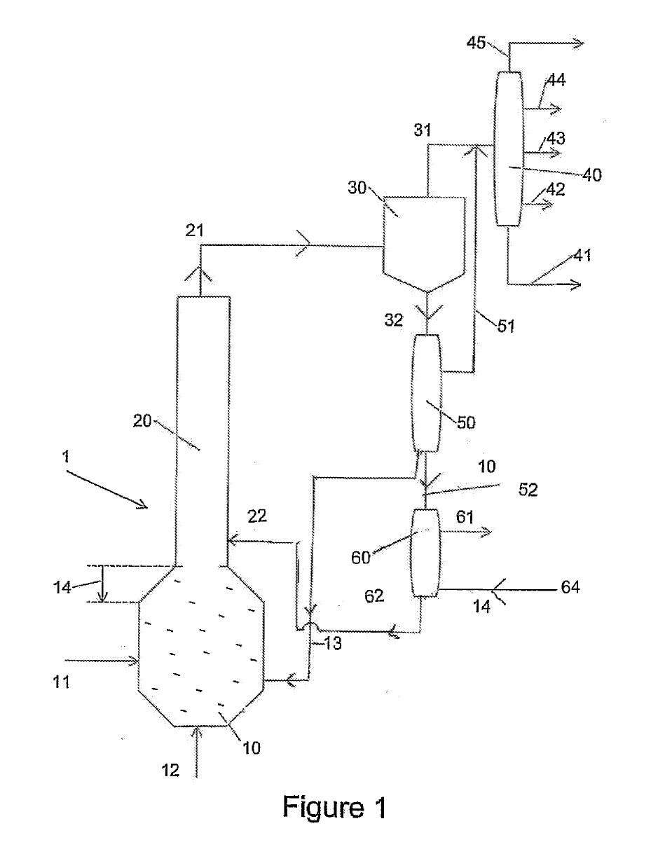

Referring to FIG. 1, a two-stage reactor 1 is shown, comprising a first stage reactor 10 and a second stage reactor 20. Entering first stage reactor 10 are biomass material 11, lift gas 12, and deactivated catalyst particles 13. In first stage reactor 10, lift gas 12 forms an expanded bed of deactivated catalyst particles 13, well mixed with biomass material 11. In area 14 of first stage reactor 10, lift gas 12 undergoes an acceleration due to the tapering shape of the first stage reactor in this area.

At injection point 22, regenerated catalyst particles 62 are injected into second stage reactor 20.

Second stage reactor 20 contains vaporized and gaseous primary reaction products of the biomass conversion, secondary reaction products, lift gas, entrained deactivated catalyst particles, injected regenerated catalyst particles and, entrained biomass particles. The biomass particles are, In some embodiments, reacted to full conversion in first stage reactor 10.

The gas/vapor/solids mixture 21 leaving second stage reactor 20 at the top is conveyed to cyclone 30, where it is split into a gas/vapor stream 31, and a solids stream 32. The vapor portion of gas/vapor stream 31 is condensed in fractionator 40. The liquid is split into fractions 41, 42, 43, and 44. Gas stream 45 can be recycled to first stage reactor 10 as lift gas 12, optionally after removal of gaseous reaction products.

Solids stream 32 from cyclone 30 is sent to stripper 50, where liquid reaction products are stripped off as stream 51, which can be combined with stream 31.

Deactivated catalyst particles 13 from stripper 50 are injected into first stage reactor 10. Solids stream 52 of deactivated catalyst particles from stripper 50 is sent to regenerator 60, where the catalyst particles are heated in a stream 64 of an oxygen-containing gas, such as air. Coke and char are burned off the heat carrier particles in regenerator 60. Flue gas 61, comprising CO and CO₂, can be combined with lift gas 12. Hot catalyst particles 62 are recycled to second stage reactor 20. Fresh catalyst carrier material 14 may be added to replenish heat carrier material lost in the form of fines, etc.

While the invention has been particularly shown and described with reference to specific embodiments, it should be understood by those skilled in the art that various changes in form and detail can be made without departing from the spirit and scope of the invention as defined by the appended claims.

What is claimed is:

1. A dual function catalyst system for use in thermolysis and catalytic cracking of biomass material, the catalyst system comprising a matrix, a densifier and a catalytically active material, wherein the catalyst system has a specific combined mesoporous and macroporous surface area in the range from about 1 m²/g to about 100 m²/g.

2. The catalyst system of claim 1 wherein the matrix comprises a clay mineral.

3. The catalyst system of claim 1 wherein the clay is a calcined clay, a metal doped clay, an acid leached clay, a base-leached clay, a delaminated clay, a dealuminated clay, a desilicated clay or combinations thereof.

4. The catalyst system of claim 1 wherein catalytically active material comprises a zeolite, a phosphated zeolite, a metal oxide, metal hydroxide, metal carbonate, metal hydroxyl-carbonate, metal phosphate or combinations thereof.

5. The catalyst system of claim 4 wherein the zeolite is a MFI zeolite, a Faujasite type zeolite or combinations thereof.

6. The catalyst system of claim 4 wherein the catalytically active material comprises a spinel form of the metal or a refractory form of the metal.

7. The catalyst system of claim 1 wherein the densifier comprises an alpha alumina, a silica, inert oxides of transition metals, refractory clay, mullite, calcined diatomite or combinations thereof.

8. The catalyst system of claim 1 further comprising a binder.

9. The catalyst system of claim 8 wherein the binder comprises polysilicic acid, aluminum chlorohydrol, aluminum nitrohydrol or combinations thereof.

10. The catalyst system of claim 2 wherein the clay mineral is the densifier.

11. A method of making a dual function catalyst system for use in conversion of biomass material, the method comprising:
a. preparing a slurry comprising a matrix, a densifier and optionally a binder;
b. shaping the slurry into shaped bodies; and
c. subjecting the shaped bodies to calcination at a temperature ranging from about 500° C. and 1,000° C.,
wherein the dual function catalyst system has a specific combined mesoporous and macroporous surface area in the range from about 1 m²/g to about 100 m²/g.

12. The method of claim 11 wherein the step (a) further comprises a zeolite or a non-zeolitic catalytic material.

13. The method of claim 11 further comprising:
d. mixing the shaped bodies in water in presence of a soluble alumina source and a soluble silica source and a zeolitic seeding material to form a slurry; and
e. subjecting the slurry of step d) to a temperature of about 175° C. thereby forming in situ grown zeolites.

14. The method of claim 13 further comprising adding a phosphorous compound before step e) or treating the shaped bodies of step b) with a phosphorous compound.

15. A process for converting solid particulate biomass material, the process comprising:
a. providing the solid particulate biomass in a reactor;
b. thermally pyrolyzing at least a portion of the solid particulate biomass in presence of a catalyst system to form primary reactions products within a first zone of the reactor; and
c. catalytically converting at least a portion of the primary reaction products into secondary reaction products in the presence of the catalytic system within a second zone of the reactor,
wherein the catalytic system has a specific combined mesoporous and macroporous surface area in the range from about 1 m²/g to about 100 m²/g.

16. The process of claim 15 wherein the primary products are oil, oil vapors or combination thereof.

17. The process of claim 15 further comprising one or more of the following:
d. stripping volatile materials from deactivated catalyst system in a stripper;
e. regenerating at least part of the deactivated catalyst system in a regenerator;
f. recycling back regenerated catalyst system to the first, the second or the first and the second zone of the reactor;
g. hydrotreating the primary or secondary reaction products in a hydrotreating reactor, the hydrotreating reactor being in fluid communication with the reactor.

18. The process of claim 17 wherein
the step of thermally pyrolyzing takes place in a first reactor and wherein the first reactor is a thermolysis reactor;
the step of catalytically converting takes place in a second reactor and wherein the second reactor is a catalytic cracking reactor;
in the step of hydrotreating, the hydrotreating reactor is a fixed bed or an ebullated bed reactor.

19. The process of claim 15 wherein in the step of thermally pyrolyzing, the temperature in the first zone is in the range of 350° C. to 600° C. and in the step of catalytically converting the temperature in the second zone is equal or higher than the temperature in the first zone.

20. The process of claim 15 wherein the catalyst system acts as a heat carrier in the step of thermally pyrolyzing and acts as a catalyst in the step of catalytically converting.
